(19) United States
(12) Patent Application Publication
(10) Pub. No.: US 2026/0143293 A1
(43) Pub. Date: May 21, 2026

(54) DEVICE LOCATION PREDICTION USING ACTIVE SOUND SENSING

(71) Applicant: HUAWEI TECHNOLOGIES CO., LTD., Shenzhen (CN)

(72) Inventors: Qiang XU, Kanata (CA); Chenhe LI, Kanata (CA); Wenhao WU, Shenzhen (CN); Peng GE, Shenzhen (CN); Wenwen ZHENG, Shenzhen (CN)

(21) Appl. No.: 19/448,294

(22) Filed: Jan. 14, 2026

Related U.S. Application Data
(63) Continuation of application No. PCT/CN2023/114829, filed on Aug. 25, 2023.

(51) Int. Cl. H04R 29/00; H04R 3/04

(52) U.S. Cl. CPC H04R 29/001; H04R 3/04; H04R 2420/07

(57) ABSTRACT

Computer implemented methods and systems for predicting device location, including recording, using a microphone on a first device, a sound recording; processing the sound recording to extract features corresponding to multipath versions of a sound sample played by a second device; classifying, based on the extracted features, a physical location of the second device as being one of either: (i) located in a same space as the first device, or (ii) not located in the same space as the first device; and performing an action on the first device based on the classifying.

### RELATED APPLICATION DATA

This application is a continuation under 35 U.S.C. § 111(a) and claims the benefit of the filing date of PCT Application No. PCT/CN2023/114829 filed Aug. 25, 2023, which designated the United States and remains pending, the entire disclosure of which is hereby incorporated by reference.

### TECHNICAL FIELD

The present application generally relates to methods, systems and computer media related to device location prediction detection based on active sound sensing.

### BACKGROUND

Electronic devices that are equipped with processors and are able to communicate with each other via various wireless protocols (such as Bluetooth, Zigbee, near-field communication, Wi-Fi, LiFi, or 5G, for example), commonly referred to as smart devices, are now ubiquitous. Several notable types of smart commercial-off-the-shelf (COTS) devices are smartphones, smart TVs, smart speakers, smart earbuds, smart thermostats, smart doorbells, smart locks, smart refrigerators, phablets and tablets, smartwatches, smart bands, smart keychains, smart glasses, and many others.

Smart COTS devices often include speakers and microphones and can support audio notifications and voice commands. In many modern use scenarios, an individual user can be associated with multiple smart devices that are able to interact with each other. Furthermore, multiple smart devices can be associated or registered with a common smart home or smart office network. Cross-device interoperation can, for example, be enabled by cooperating software installed on multiple devices. For example, a distributed operating system can enable multiple smart devices to collaborate and interconnect with each other, particularly when located in close proximity to each other. Cross-device interoperation is often desired when devices are located in a common or same space such as the same room (e.g., a room in a residence such as a living room, bedroom, den, home office, family room, kitchen or a room in a business or commercial setting such as a meeting room or office) or a vehicle interior (e.g., interior of car, RV, boat, bus, etc.).

A critical precursor for cross-device interoperation within a same space is the ability of the respective devices to detect and identify other devices that are present in the same space to interact with. Desired features of same space cross-device detection solutions for electronic devices include: (1) ubiquity (e.g., the solution can be easily implemented on a wide range of COTS devices); (2) efficiency (e.g., the solution can enable efficient use of computational/memory resources, while being cost-efficient); (3) accuracy (e.g., the solution can successfully detect and identify other devices in a common space with high accuracy); (4) coverage (e.g., the solution covers all or substantially all of the common space); (5) robustness (e.g., the solution is robust against interference), and (6) privacy (e.g., the solution mitigates or does not introduce privacy concerns).

Same space detection solutions have been proposed, but such solutions typically lack at least some of the desired features noted above. For example, some device detection systems rely on images captured by built-in camera of a device. Through processing and analyzing these images, a device can learn about its environment, including information about the presence of objects or users around the device and the distances between them. Computer vision based techniques have been developed for many years, and can provide a high degree of accuracy; however, camera based solutions raise privacy concerns as users can feel that they are being watched and monitored. Additionally, the camera in a device typically has a limited field of view, and thus provides limited directional coverage for detecting other objects.

Another existing solution is using electromagnetic (EM) fingerprint-based technologies to detect electronic devices. This solution uses an EM signal site survey to collect Wi-Fi, BLE signal strength, or magnetic fingerprint data for various devices that can be located within a space to create a local fingerprint dataset. A probing-enabled device can then collect location fingerprints and estimate locations of other devices within a space using the fingerprint dataset. This solution requires EM site surveys and can lack robustness and accuracy.

Some known solutions apply two-way ranging to determined distance between devices. In such solutions, a Time of Flight (TOF) of an Ultra Wide Band radio frequency signal or an acoustic signal is measured and used to calculate the distance between two devices. Although two-way ranging can indicate a distance between objects, it does not indicate if the two objects are physically within the same interior space.

Thus, existing solutions for same space detection all have their respective shortcomings. There is a need for methods, systems and computer media for same space device detection that can address the shortcomings of the known solutions.

### SUMMARY

According to a first example aspect a computer implemented method is disclosed for detecting devices within an environment. The method includes: recording, using a microphone on a first device, a sound recording; processing the sound recording to extract features corresponding to multipath versions of a sound sample played by a second device; classifying, based on the extracted features, a physical location of the second device as being one of either: (i) located in a same space as the first device, or (ii) not located in the same space as the first device; and performing an action on the first device based on the classifying.

In some examples, the sound sample is within a frequency range that is inaudible to humans.

In one or more of the preceding aspects, processing the sound recording includes performing band pass filtering to obtain a sound signal within a defined frequency band, performing matched filtering on the sound signal to extract a time series corresponding to the multipath versions of the sound sample played by the second device, and extracting the features from the time series.

In one or more of the preceding aspects, prior to extracting the features, processing the time series to identify a first index sound segment within the time series that corresponds to a shortest sound propagation path of the multipath versions of the sound samples from the second device to the first device, the features are extracted based on properties of a subset of the time series selected based on the first index sound segment.

In one or more of the preceding aspects, the features comprise one or more of: a maximum amplitude magnitude value included within the selected subset; an average amplitude magnitude value of the selected subset; a standard deviation amplitude value of the selected subset; a kurtosis amplitude value of the selected subset; a skewness amplitude value of the selected subset; a 25th percentile amplitude value of the selected subset; a 75th percentile amplitude value of the selected subset; a root mean square amplitude value of the selected subset; a number of sampled amplitude values within the selected subset that are larger than a product of a defined coefficient value and the maximum amplitude magnitude value; a sum value of a defined number amplitude peak values occurring within the selected subset; a time offset between a first occurring amplitude peak value and a last amplitude peak value of the selected subset; an average magnitude value of amplitude peak values included within the selected subset; a standard deviation value of amplitude peak values included within the selected subset; a kurtosis value of the amplitude peak values included within the selected subset; a skewness value of the amplitude peak values included within the selected subset; a 25th percentile value of the amplitude peak values included within the selected subset; and a 75th percentile value of the amplitude peak values included within the selected subset.

In one or more of the preceding aspects, processing the time series to identify the first index sound segment comprises: (i) identifying a maximum amplitude peak value within the time series; (ii) identifying if there are any amplitude peak values that meet defined amplitude peak value criteria and are located within a defined search range preceding the maximum amplitude peak value; and (iii) if one or more amplitude peak values are identified within the defined search range, selecting an amplitude peak value that immediately precedes the maximum amplitude peak value to identify the first index sound segment, and if no amplitude peak values are identified within the defined search range, selecting the maximum amplitude peak value to identify the first index sound segment.

In one or more of the preceding aspects, classifying the physical location of the second device comprises applying an artificial intelligence model that has been trained to classify the physical location of the second device as being one of either: (i) located in the same space as the first device, or (ii) not located in the same space as the first device.

In one or more of the preceding aspects, classifying the second device as being located in the same space as the first device corresponds to the second device being physically located within a same room of a building as the first device, and classifying the second device as not being located in the same space as the first device corresponds to the second device not being physically located in the same room of the building as the first device.

In one or more of the preceding aspects, classifying the second device as being located in the same space as the first device corresponds to the second device and the first device both being physically located within a continuous interior space of a vehicle and classifying the second device as not being located in the same space as the first device corresponds to corresponds to the second device and the first device not being both physically located within a continuous interior space of a vehicle.

In one or more of the preceding aspects, the sound sample has a frequency of 17.5 KHz or greater.

In one or more of the preceding aspects, the sound sample has a frequency of between approximately 20 to 24 KHz.

In one or more of the preceding aspects, the sound sample includes a fade-in tone portion, a constant amplitude chirp portion, and a fade-out tone portion.

In one or more of the preceding aspects, performing the action on the first device based on the classifying comprises causing media content to be automatically streamed for playback through a speaker of the second device when the classifying classifies the physical location of the second device as being located in the same space as the first device.

In one or more of the preceding aspects, wherein performing the action on the first device based on the classifying comprises causing a notification output to be generated by the first device indicating an absence of the second device when the classifying classifies the physical location of the second device as not being located in the same space as the first device.

In one or more of the preceding aspects, performing the action on the first device based on the classifying comprises causing the first device to establish a connection with the second device to share media content with the second device when the classifying classifies the physical location of the second device as being located in the same space as the first device.

In one or more of the preceding aspects, the first device, the second device and one or more further devices are each associated with a common wireless network, wherein: the sound recording includes received multipath versions of the sound sample played by the second device and one or more further sound samples respectively played by the one or more further devices; processing the sound recording comprises extracting further features, the further features including respective features corresponding to the one or more further sound samples; and the classifying further comprises classifying, based on the further features, a physical location of each of the one or more further devices as either: (i) the further device being located in a same space as the first device, or (ii) the further device not being located in a same space as the first device.

In one or more of the preceding aspects, the method includes transmitting, by the first device, a request via the common wireless network for the second device to play the sound sample and the one or more further devices to each play a respective one of the one or more further sound samples, wherein the sound sample and the one or more further sound samples have unique waveform properties that enable the sound sample and the one or more further sound samples to be uniquely identified.

In one or more of the preceding aspects, the method includes determining a total number of the second device and the one or more further devices are physically located with the same space with the first device based on the classifying, wherein performing the action on the first device is based on the total number. In some examples, performing the action on the first device comprises: (i) when the total number is one, causing media content to be automatically streamed or shared for playback by the second device or the one more device of the further devices that has been classified as being located in the same space as the first device; (ii) when the total number is greater than one, presenting user selectable device options by the first device that identify devices that have been classified as being located in the same space as the first device; and (iii) when the total number is zero, generating an output by the first device indicating to a user that no devices have been classified as being located in the same space as the first device.

According to a further example aspect, a system is disclosed that includes or more processors, and one or more memories storing machine-executable instructions thereon which, when executed by the one or more processors, cause the system to perform the method of any one of the preceding methods.

According to a further example aspect, a non-transitory processor-readable medium is disclosed having machine-executable instructions stored thereon which, when executed by one or more processors, cause the one or more processors to perform the method of any one of the preceding methods.

According to a further example aspect, computer program is disclosed that configures a computer system to perform the method of any one of the preceding methods.

### BRIEF DESCRIPTION OF THE DRAWINGS

Reference will now be made, by way of example, to the accompanying drawings which show example embodiments of the present application, and in which:

FIG. 1 is a block diagram illustrating an example of an interior environment to which example embodiments of proximity detection using active sound sensing can be applied;

FIG. 2 is a block diagram of a processor system that can be used to configure an electronic device to implement a proximity detection using active sound sensing in the environment of FIG. 1, according to example embodiments;

FIG. 3 is a flow diagram representing a detection procedure that can be performed according to example implementations;

FIG. 4A is a frequency v. time plot representing a transmitted sound sample according to example implementations;

FIG. 4B is an amplitude v. time plot representing the transmitted sound sample according to example implementations;

FIG. 5 includes a first plot representing a time series of sound segments extracted from a received sound recording;

FIG. 6 is a flow diagram representing a further example of a detection procedure that can be performed according to example implementations;

FIG. 7A shows an electronic device displaying a quick setting panel as part of a graphical user interface (GUI);

FIG. 7B shows the electronic device displaying a GUI representing a first possible action;

FIG. 7C shows the electronic device displaying a GUI representing a second possible action;

FIG. 7D shows the electronic device displaying a GUI representing a third possible action;

FIG. 8 is a flow diagram representing a further example of a detection procedure that can be performed according to example implementations; and

FIG. 9 is a flow diagram representing a further example of a detection procedure that can be performed according to example implementations.

Similar reference numerals may have been used in different figures to denote similar components.

### DETAILED DESCRIPTION

This disclosure describes methods, systems and computer media for device detection using active sound sensing. In some examples, the detection can be used to identify electronic devices that are located in a same space. In at least some examples, a first electronic device is considered to be in the “same space” as a second electronic device when the first device and the second device are located within a common physical space that is not divided by walls or other space delimiting barriers. For example, a same space can be: a continuous space within a building or other structure that may be separated by room delimiting barriers from other spaces of the building or structure; a cabin or other continuous interior space of a vehicle; and a continuous space within an outdoor region. In example embodiments, a determination that the first and second devices are located in the same space is made based on features that are extracted from sound samples played by a speaker of the second device and received by a microphone of the first electronic device. In particular, the extracted features are analyzed to determine if they meet criteria that are representative of the first and device and the second device being located within a same space. In example implementations, the sound sample is designed to be inaudible to typical humans. In example implementations, standard electronic devices (e.g., COTS devices) are configured with software that enables such devices to perform active sound sensing to detect and identify nearby devices, for example, devices that are in the same space, without requiring additional hardware.

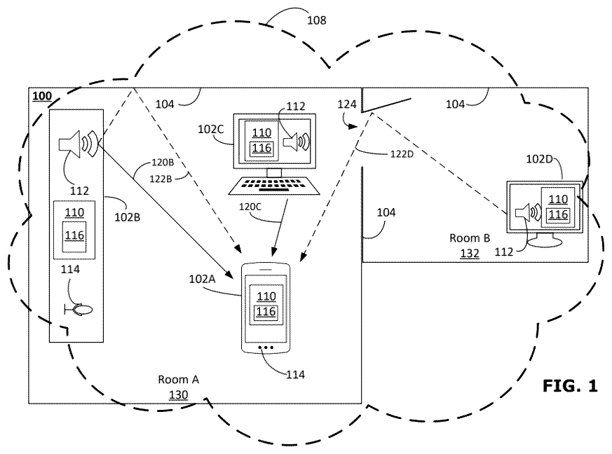

FIG. 1 is a block diagram illustrating an example of an interior environment 100 in which examples described herein can be applied. In illustrated examples the environment 100 is an enclosed environment that includes multiple interior spaces or regions 130, 132 that are each defined by respective sets of space delimiting barriers 104 that are static relative to the interior region and can be at least partially sound reflecting. Objects that are co-located in space 130 are located in a “same space”. Objects that are co-located in space 132 are located in a “same space”. By way of contrast, an object (e.g., electronic device 102A) that is located in space 130 and an object that is located in space 132 (e.g., electronic device 102D) are not located in a “same space”. By way of example, in some scenarios, environment 100 can be an indoor environment of a home or office or other structure in which the space delimiting barriers 104 include walls, floors, ceilings, closed windows and closed doors, with the interior spaces 130, 132 being discrete rooms (e.g., Room A and Room B). In the illustrated example, the interior spaces 130, 132 are generally separated by barriers 104, but can be joined by an unobstructed opening 124 (for example, an open doorway). In some alternative examples, environment 100 can be the interior of a vehicle, with space delimiting barriers 104 including the structural elements that define a cabin or interior space of the vehicle. Further, environment 100 can include a number of objects (not shown) that are space delimiting barriers such as furniture, plants, decorations and the like.

In the example of FIG. 1, the environment 100 includes multiple electronic devices 102A, 102B, 102C and 102D (generically and collectively referred to as electronic devices 102) that are configured to interact with each other through a local wireless network 108. By way of example, electronic devices 102 may all be preregistered with a smart network (for example, a smart home network) that is associated with local wireless network 108. The identity of, and other devices data, of smart network member electronic devices 102 can, for example, be maintained in a distributed register that is accessible to each of the member electronic devices 102 when they are active in the smart network. Electronics devices 102 are each processor-enabled devices that include a respective processor system 110 and one or both of: (i) a speaker 112 for converting an input audio signal into output sound waves that are propagated into the environment 100 and (ii) a microphone 114 for capturing sound that is propagating within the environment 100 and converting that sound into an input audio signal. The electronic devices 102, at least some of which can be COTS devices, have been provisioned with specialized software instructions that configure their respective processor systems 110 with a detection module 116 that enables the electronic devices 102 to perform one or more active sound sensing functions as described herein. For example, electronic devices 102 can include, among other things, COTS devices such as a smart TV (e.g., device 102D), an interactive smart speaker system (e.g., device 102B), a workstation (e.g., device 102C), and a smart phone (e.g., device 102A), among other smart devices.

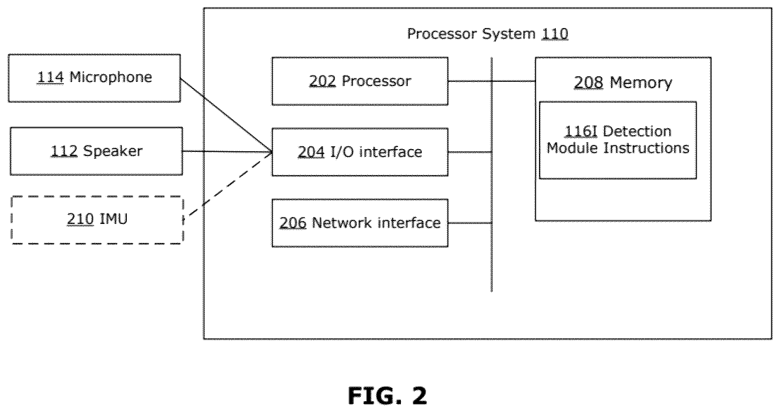

FIG. 2 illustrates an example of a processor system 110 architecture that could be applied to any of the respective electronic devices 102. Processor system 110 includes one or more processors 202, such as a central processing unit, a microprocessor, a graphics processing unit (GPU), an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 202 may collectively be referred to as a “processor device”. The processor system 200 also includes one or more input/output (I/O) interfaces 204, which interfaces with input devices (e.g., microphone 114) and output devices (e.g., speaker 112). In some examples, further I/O devices, such as an inertial measurement unit (IMU) 210, can also be connected to provide input data to (or received output data from) processor system 110.

The processor system 110 can include one or more network interfaces 206 that may, for example, enable the processor system 110 to communicate with one or more further devices through wireless local network 108 using one or more wireless protocols (such as Bluetooth, Zigbee, near-field communication, Wi-Fi, LiFi, or 5G, for example).

The processor system 110 includes one or more memories 208, which may include a volatile or non-volatile memory (e.g., a flash memory, a random access memory (RAM), and/or a read-only memory (ROM)). The non-transitory memory(ies) 208 may store instructions for execution by the processor(s) 202, such as to carry out examples described in the present disclosure. The memory(ies) 208 may include other software instructions, such as for implementing an operating system and other applications/functions. In the illustrated example, the memory 208 includes specialized software instructions 1161 for implementing detection module 116.

In some examples, the processor system 110 may also include one or more electronic storage units (not shown), such as a solid state drive, a hard disk drive, a magnetic disk drive and/or an optical disk drive. In some examples, one or more data sets and/or modules may be provided by an external memory (e.g., an external drive in wired or wireless communication with the processor system 110) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The components of the processor system 200 may communicate with each other via a bus, for example.

As used here, a “module” can refer to a combination of a hardware processing circuit (e.g. processor 202) and machine-readable instructions (software (e.g., detection module instructions 1601) and/or firmware) executable on the hardware processing circuit.

In example embodiments, the electronic devices 102 are configured by their respective detection modules 116 to cooperatively perform an active sound sensing procedure that enables a first electronic device (e.g., device 102A) to detect and identify which of the other devices 102 are located near the first electronic device. For example, the active sound sensing procedure can be used to detect which or the other devices 102B, 102C and 102D are located in the same space (e.g., interior space 130) as the first electronic device 102A. In example embodiments, first electronic device 102A is configured to perform one or more operations based on the detected devices.

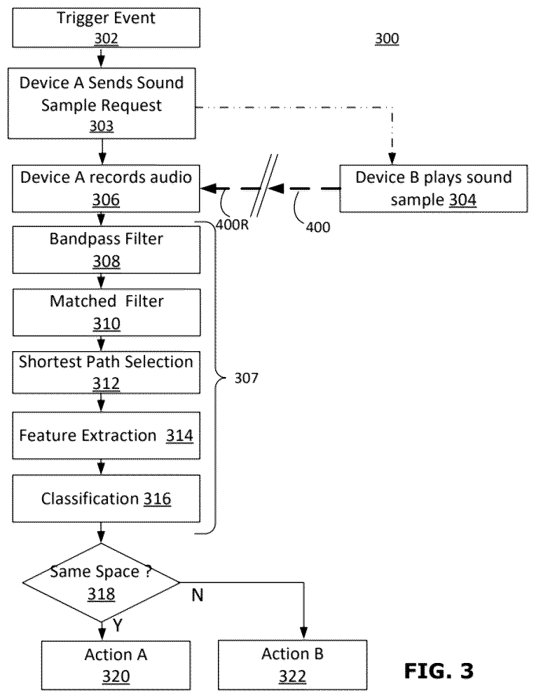

FIG. 3 shows a flow diagram illustrating a basic example of a same space detection procedure 300 that can be performed in respect of a first electronic device (e.g., device 102A) and a second electronic device (e.g., device 102B) in the context of environment 100 of FIG. 1.

The procedure 300 commences with a trigger event (operation 302). Although the trigger event can take a number forms, in an example embodiment, the trigger event is detected by first device 102A. For example, the operating system of first device 102A can be configured to monitor for one or more predefined user input events that correspond to trigger events and notify the detection module 116 of first device 102A upon the occurrence of such an event and the type of event. For example, a trigger event could result from a user input (for example a button selection, verbal command, gesture) requesting that a song be streamed through the first device 102A for sound output through an external device (e.g., a casting or sharing request).

In one example, following detection of a trigger event (operation 302), the detection module 116 of first device 102A causes a sound sample request (operation 303) to be sent to one or more of the further electronic devices 102 present in environment 100. In one example, the sound sample request can be an RF message sent via local wireless network 108 and can include a type indication as to the reason for the request (e.g., request type=seeking device to play audio). In some examples, the sound sample request can be broadcast (for example through one or more access points or routers of the local wireless network 108) to all further devices 102 that currently are registered as active within the local wireless network 108. In some examples, the sound sample request can be addressed to one or more specific further devices 102 that are known to the first device 102A.

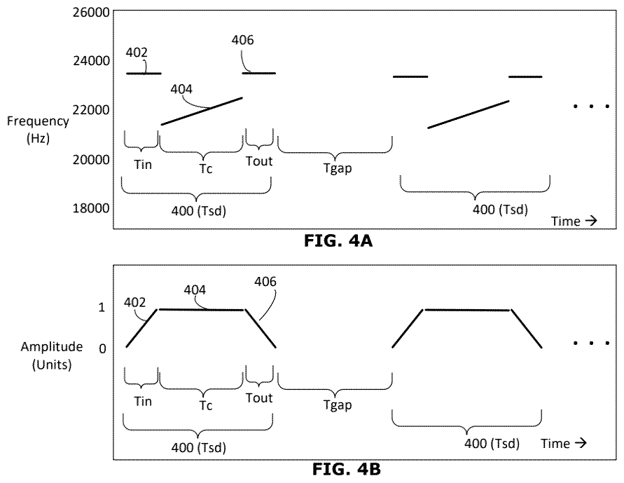

In the present example, the second electronic device 102B, receives the sound sample request via local wireless network 108. The sound sample request is passed to detection module 116 of the second electronic device 102B, and in response, the detection module 116 of the second electronic device 102B causes that device to play one or more predefined sound samples 400 through its speaker 112 (operation 304) . . . . The sound sample 400 can take a number of different forms in different applications. For example, each sound sample 400 could be a tone pulse, a chirp, a combination of a pulse and a chirp, a Zadoff-Chu sequence, or other coded signal sequence. In at least some examples, each of the devices 102 can be pre-associated with a unique predefined sound sample during a configuration stage such that the identity of a device transmitting a sound sample can be identified by a receiving device. For example, each device 102 can be assigned a unique sound sample waveform. For illustrative purposes, an example waveform of predefined sound sample 400 that may be transmitted by electronic device 102B is illustrated in FIGS. 4A and 4B which respectively show frequency and amplitude versus time plots. In example implementations, the predefined sound sample 400 assigned to each electronic device 116 is configured so to minimize interference with normally audible human hearing sounds, but at the same time fall within a range of sound frequencies that can be generated by a speaker of a typical COTS electronic device and measured by a microphone of a typical COTS device. By way of example, in the case of a COTS device with a microphone that supports a 48 KHz sampling rate, a predefined frequency range used for sound sample 400 may be between approximately 20 to 24 KHz. In the case of a COTS device with lower sampling rate microphones a predefined frequency range used for sound sample 400 may be between approximately 17.5 KHz to 20 KHz.

In this regard, in an illustrated example, the predefined sound sample 400 falls within or close to an ultrasonic range that is at or above an upper end of human audible sounds. Sound signals within or close to the ultrasonic range tend to have a relatively short bandwidth such that they decay very fast in an air medium and also reflect from many different types of surfaces. These properties make such sound signals very suitable for enabling detection of electronic devices that are within the same space. In an illustrated and non-limiting example, the predefined sound sample 400 includes a fade-in tone portion 402 for a fade-in duration (Tin), followed by a chirp portion 404 for a chirp duration (Tc), followed by a fade-out tone portion 406 for a fade-out duration (Tout). Fade-in tone portion 202 has a constant frequency (e.g., 23.2 KHz) and linearly increases in amplitude (e.g., volume of zero to a sound sample maximum volume) over its duration (Tin) (e.g., Tin=10 ms). Chirp tone portion 204 has a linearly changing frequency (e.g., increasing from 21.8 KHz to 22.6 KHz) and a constant amplitude (e.g., sound sample maximum volume) over its duration (Tc) (e.g., Tc=25 ms). Fade-out tone portion 206 has a constant frequency (e.g., 23.2 KHz) and linearly decreases in amplitude (e.g., volume of sound sample maximum volume down to zero) over its duration (Tout) (e.g., Tout=10 ms). In the illustrated example, the total sound sample duration (Tsd) is 45 ms.

In some examples, second electronic device 102B will respond to a sound sample request by playing a periodic sequence of a predefined number of the sound samples 400, with the successive sound segments 402 being separated by null or gap durations (Tgap). In a particular illustrative and non-limiting example, the gap duration (Tgap) between each of the sound samples is Tgap=35 ms, and the number of sound soound samples included in the sequence is three.

The sounds sample format described above is illustrative and in some examples, different waveform configurations, frequencies, and numbers of sound samples other than the above example can be used. Furthermore, as noted above, device-specific sound samples 400 having unique waveforms (having unique segments 402) can be assigned for different electronic devices 102 to enable device differentiation. For example, the sound samples 400 associated with second device 102B and third device 102C could have the following respective waveform properties:

TABLE 1
Waveform Properties for Different Transmitting Devices

| Waveform Property | Second Device 102B | | Third Device 102C | |
|---|---|---|---|---|
| Fade-In Tone 402 | 23.2 | KHz | 23.2 | KHz |
| Frequency | | | | |
| Fade-In Tone 402 | 10 | ms | 10 | ms |
| Duration (Tin) | | | | |
| Fade-In Tone 402 | 0 to 1 | | 0 to 1 | |
| Amplitude | | | | |
| Chirp 404 Frequency | 21.8 to 22.6 KHz | | 20.8 KHz to 21.6 KHz | |
| Chirp 404 Duration (Tc) | 10 | ms | 10 | ms |
| Chirp 404 Amplitude | 1 | | 1 | |
| Fade-Out Tone 406 | 23.2 | KHz | 23.2 | KHz |
| Frequency | | | | |
| Fade-Out Tone 406 | 10 | ms | 10 | ms |

| | | |
|---|---|---|
| Duration (Tout) | | |
| Fade-Out Tone 406 | 1 to 0 | 1 to 0 |
| Amplitude | | |

Referring again to FIGS. 1 and 3, in addition to sending out sound sample request, the first device 102A is also configured by its detection module 116 to begin recording, via its microphone 118, a received sound recording 400R for a duration that is the same duration (or longer) as that of the transmitted sound sample 400 duration (Tsd) (operation 306). In examples where the sound sample 400 is part of a sequence of a predefined number of multiple sound samples (e.g., a sound sample sequence of N sound samples 400), the recording duration for received sound recording 400R could, for example, be set to an expected length of the sound sample sequence, e.g., N*Tsd*Tgap.

The received sound recording 400R is then processed by a set of processing operations 307 to determine: (i) location data indicating a relative location of the second device 102B the first device 102A, and (ii) identity data indicating an identity of the second device 102.

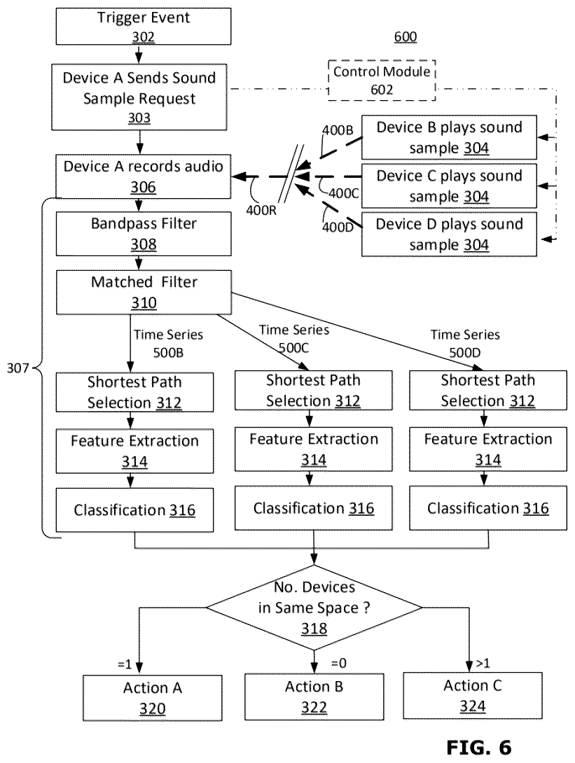

In the illustrated example, processing operations 307 can include operations 308 to 316 as follows. Bandpass filtering (operation 308) is applied to the received sound recording 400R to extract a sound signal falling within the near ultrasonic/ultrasonic bandwidth (e.g., approximately 17.5 KHz to approximately 22 KHz, by way of non-limiting example) that corresponds to the transmitted sound sample 400. Matched filtering (operation 310) is then performed on the extracted sound signal to extract a time series of sound segments that match the transmitted sound sample 400. Matched filtering could for example be based on correlating sound segments within the received sound recording 400R with the possible waveforms that are known for transmitted sound samples 400. In at least some examples where the environment includes multiple electronic devices 102 that have each transmitted a respective sequence of one or more unique sound samples 400 in response to a sample request from first device 102A, the received sound recording 400R can be a composite of unique sound samples 400 from the multiple electronic devices 102. In some examples, matched filtering (operation 310) can be applied based on pre-assigned waveform patterns to extract a respective time series of received sound samples for each of the transmitting electronic devices 102. In such cases, as will be described below in respect of FIG. 6, the remaining operations (e.g., operations 312, 313 and 316) can be performed respectively for each extracted time series of sound samples, and the identity of the respective transmitting device corresponding to each extracted time series will be known to the receiving first device 102A. In some alternative examples, each participating sound sample transmitting device 102B, 102C, 102D can have the same waveform for their respective sound samples, but be assigned different time slots to transmit their respective sound samples.

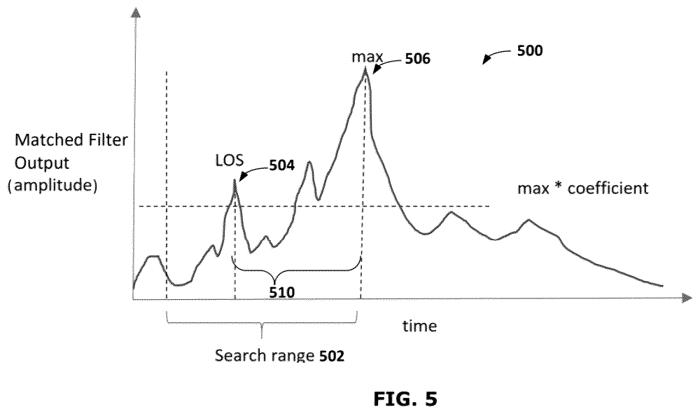

With reference to FIG. 1, and considering the example where the received sound recording 400R has been recorded to capture a sound sample 400 transmitted by the second device 102B, it will be noted that the received sound recording 400R will actually include a composition of multiple received versions of the transmitted sound sample 400 due to a multipath effect caused by sound reflections within the environment 100. For example, a direct or LOS sound propagation path 120B (illustrated using a solid line) is shown for sound sample 400 between second device 102B and first device 102A, along with an indirect or non-LOS path 122B (illustrated using a dashed line). The extracted time series of sound samples 400 generated by matched filtering from received sound recording 400R will include the multipath result. By way of example, FIG. 5 illustrates an example of a time series 500 output by matched filter 310 as extracted from received sound recording 400R. The extracted time series 500 represents multipath versions of the sound sample 400 played by second device 102B as received by the first device 102A.

In example embodiments, the time series generated by matched filter operation 310 is processed to select a part of the time series that represents the received sound sample that has travelled the shortest path (shortest path selection operation 312). In the particular illustrated example, the time series 500 is processed to identify a first index sound segment present within the extracted time series 500. In the illustrated example of FIG. 5, the first index sound segment (represented by local amplitude value peak 504) represents the sound sample 400 that has been received through the shortest sound propagation path (e.g., LOS propagation path 120B) between the transmitting electronic device (e.g., second device 102B) and the receiving electronic device (e.g., first device 102A). In example embodiments, shortest path selection applies informed search techniques to identify the first index sound sample.

In one example, shortest path selection can include the following operations. (i) First, identify the maximum amplitude peak value within the time series 500 of the matched filter output (in the illustrated example of FIG. 5, peak value 506 is identified as the maximum amplitude peak value; note that in various scenarios, the maximum amplitude peak value can correspond to either a shortest path or a strongest reflection). (ii) Second, identify if there is an amplitude peak value that meets defined amplitude peak value criteria and is located within a defined search range 502 preceding the maximum amplitude peak value 506. In the illustrated example, defined peak value criteria is a threshold amplitude that is the product of the maximum amplitude value (e.g., peak value 506) and a predefined coefficient value (e.g., 0.4, although other values can be used based on analysis of historical results). The search range 502 can be set at a duration that is expected to include multipath representations of a transmitted sound sample. (iii) Third, if the search range 502 includes one or more amplitude peak values (e.g., peak value 504 in the illustrated example) that meets the defined amplitude peak value criteria, the peak value (e.g., peak value 504) that immediately precedes the maximum peak value (e.g., peak value 506) is selected as representing the first index sound segment that corresponds to the shortest path. If the search range 502 does not include any amplitude peak values that meet the defined amplitude peak value criteria, then the maximum peak value itself is selected as representing the first index sound segment that corresponds to the shortest path.

By way of illustration, in the example of FIG. 5, peak value 504 is identified as representing the first index sound segment that corresponds to the shortest path (which in the present example is an LOS path).

Once a first index segment is selected, a corresponding subset 510 of the search range 502 can be extracted for further evaluation. The subset 510 could for example be based on the predefined period of the sound sample 400 and the time location of the selected first index sound segment. In some examples, the subset 510 may be a duration that is selected to include the first index sounds segment and the maximum peak value (e.g., a time duration that includes a duration that extends from first index segment amplitude peak value 504 to maximum index amplitude peak value 506. In some examples, the subset 510 may be equal to the search range 502.

It will be appreciated that identification of the subset 510 of the matched filter output that corresponds to a sound sample 400 that has travelled the shortest propagation path is, in at least some scenarios, not definitive of whether or not the identified subset 510 corresponds to an LOS path. For example, in situations where no LOS path exists, multiple non-LOS paths can still exist, and one of the non-LOS paths will be identified as the selected as the shortest propagation path.

Referring again to FIG. 3, once shortest path selection (operation 312) has been performed to identify of a subset 510 of the time series of the time series 500, a set of features can be extracted (operation 314) from the subset 510. By way of example, the set of features can include one or more of:
a. a maximum amplitude magnitude value included within the selected subset 510;
b. an average amplitude magnitude value of the selected subset 510;
c. a standard deviation amplitude value of the selected subset 510;
d. a kurtosis amplitude value of the selected subset 510;
e. a skewness amplitude value of the selected subset 510;
f. a 25th percentile amplitude value of the selected subset 510;
g. a 75th percentile amplitude value of the selected subset 510;
h. a root mean square amplitude value of the selected subset 510;
i. a ratio of sampled amplitude values within the selected subset 510 that are larger than a coefficient value (For example, 0.1,0.2) times the maximum value (a.);
j. a sum value of a defined number (e.g., 9) local maximum amplitude peak values occurring after a first index amplitude peak value within the selected subset 510;
k. A time offset between a first occurring amplitude peak value and a last amplitude peak value of the selected subset 510;
l. an average magnitude value of amplitude peak values included within the selected subset 510;
m. a standard deviation value of the amplitude peak values included within the selected subset 510;
n. a kurtosis value of the amplitude peak values included within the selected subset 510;
o. a skewness value of the amplitude peak values the included within the selected subset 510;
p. a 25th percentile value of the amplitude peak values included within the selected subset 510; and/or
q. a 75th percentile value of the amplitude peak values included within the selected subset 510.

The extracted features are then provided as inputs to a classification operation (operation 316) that is configured to output an outcome indicating a relative location of the transmitting electronic device (e.g., second device 102B) to the receiving electronic device (e.g., first device 102A). In the illustrated example, the relative location is one of two possible states, namely the transmitting electronic (e.g., second device 102b) either: (a) IS located in the same space as the receiving electronic device (e.g., first device 102A); or (b) IS NOT located in the same space as the receiving electronic device (e.g., first device 102A)).

In some examples embodiments, classification operation 316 is performed based on a set of pre-defined rules that can, for example, be determined based on expert statistical analysis of extracted features in a number of different real and/or simulated use case scenarios. In some example embodiments, classification operation 316 can be performed using a trained artificial intelligence model that has been trained to distinguish between “IN same space” and “NOT IN same space” scenarios using a training dataset derived from multiple real and/or simulated use case scenarios.

The classification outcome ((a) IS located in same space or (b) IS NOT located in the same space) is used to determine (decision operation 318) a course of action for the first device 102A (e.g., when classification outcome is (a), do Action A 320, when classification outcome is (b), do Action B 320. By way of example, in the case where the trigger event for procedure 300 resulted from a user input requesting that a song (or other audio media content) be streamed through the first device 102A for sound output through an external device, Action A 320 can be to cause the song (or other audio media content) to be automatically streamed for playback through the speaker 112 of second device 102B and Action B 320 can be to cause an output to be generated by a user interface of first device 102A informing the user that an external speaker is not available. In this regard, the action comprises causing a notification output to be generated by the first device 102A indicating an absence of the second device 102B when the classifying classifies the physical location of the second device 102B as not being located in a same space as the first device 102A.

In some examples embodiments, classification operation 316 is performed based on a set of pre-defined rules that can, for example, be determined based on expert statistical analysis of extracted features in a number of different real and/or simulated use case scenarios. In some example embodiments, classification operation 316 can be performed using a trained artificial intelligence model that has been trained to distinguish between “IN same space” and “NOT IN same space” scenarios using a training dataset derived from multiple real and/or simulated use case scenarios.

A basic example having been provided, further configurations and use case examples of the methods, systems and computer media for device detection using active sound sensing will now be described that build on the basic example provided above.

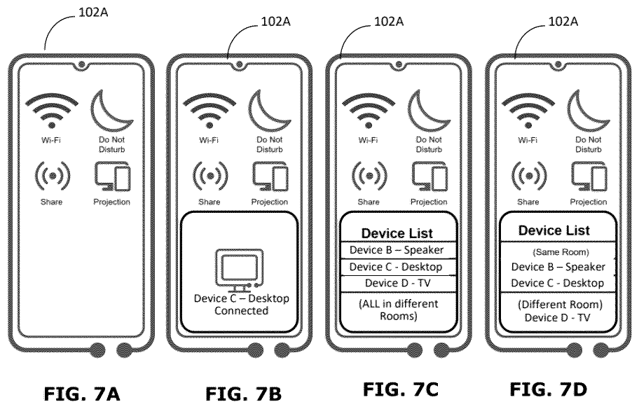

In this regard FIG. 6 shows a flow diagram illustrating an example same space detection procedure 600 that builds on procedure 300 and can be performed in respect of a first electronic device (e.g., smartphone device 102A), a second electronic device (e.g., smart speaker device 102B), a third electronic device (e.g., desktop device 102C) and a fourth electronic device (e.g., smart TV device 102D) in the context of environment 100 of FIG. 1. In the illustrated example, same space detection procedure 600 is performed in response to detection of a trigger event (operation 302) corresponding to user input at first device 102A requesting that content be shared with or projected to another smart device. By way of example, FIG. 7A shows an example of first device 102A displaying a “quick settings” graphical user interface (GUI) panel that includes “share” and “projection” buttons. Trigger event in operation 302 can correspond to user selection of one of the “share” and “projection” buttons.

Referring again to FIG. 6, in response to the trigger event, the first device 102A initiates a sound sample request that is sent as a RF message for the other devices (devices 102B, 102C, 102D) that are connected to local area network 108. In some examples the sound sample request may be facilitated through a smart network control module 602 that is connected to local area network 108 and may be hosted on one or more of the electronic devices 102 or on a further device. For example, the detection module 116 of first device 102A could cause a sound sample request to be provided to smart network control module 602 via local area network 108, which in turn distributes the request to devices that are connected to local area network 108 and that have the technical capability to participate in the content share/project.

The participating devices 102B, 102C, 102D each respond to the sound sample request by playing a respective sound sample 400B, 400C, 400D, using their respective speakers 112 (operations 304). In some examples, as noted above, each of the devices 102B, 102C, 102D has been assigned a respective sound sample 400B, 400C, 400D that has a unique waveform to enable waveform differentiation between the different sound samples 400B, 400C, 400D. In some alternative examples, each participating device 102B, 102C, 102D can have the same waveform for their respective sound samples 400B, 400C, 400D, but be assigned different time slots to transmit their respective sound samples. By way of example, control module 602 may assign second device 102B an initial sound sample timeslot at time T (of duration Tsd), assign third device 102C next sound sample timeslot at time T+Tsd (of duration Tsd), and assign fourth device 102D a further sound sample timeslot at time T+2Tsd (of duration Tsd). Control module 602 can further advice the first device 102A of the assigned timeslot order for the devices 102B, 102C, 102D, enabling time-slot differentiation between the devices.

Concurrent with the transmission of sound samples 400B, 400C and 400D respectively by second, third and fourth devices 102B, 102C and 102D, the first device 102A records a received sound recording 400R using its microphone 114 (operation 306A), and then applies bandpass filtering (operation 308 to the received sound recording 400R to extract a sound signal corresponding to the bandwidth of the transmitted sound samples 400B, 400C, 400D. Matched filtering (operation 310) is then performed on the extracted sound signal to extract a respective time series time series 500B, 500C and 500D that respectively correspond to the transmitted sound samples 400B, 400C, 400D. Matched filtering could for example be based on correlating sound segments within the received sound recording 400R with the waveforms that are known for the transmitted sound samples 400B, 400C and 400D. In examples that rely on waveform differentiation to distinguish between sound samples 400B, 400C and 400D, the received sound recording 400R will be a composition of received versions of the transmitted sound samples 400B, 400C and 400D all included within a common duration that includes the sound sample duration Tsd. Correlation techniques can be used to extract each of the individual time series 500B, 500C and 500D. In the examples that rely on timeslot differentiation to distinguish between sound samples 400B, 400C and 400D, the received sound recording 400R will include received versions of the transmitted sound samples 400B, 400C and 400D, each falling within a successive timeslot of approximately the sound sample duration Tsd such that the received sound recording 400R will have a duration of greater than 3Tsd. Correlation techniques can be used to extract each of the individual time series time series 500B, 500C and 500D from its respective timeslot.

It will be appreciated that the waveform differentiation approach can require less recording time during audio recording operation 306 by receiving device 102A as all of the unique waveform sound samples are transmitted simultaneously, but can require more complex correlation operations at matched filtering operation 310 to distinguish between the respective waveforms. In comparison, the timeslot differentiation approach can require a longer recording time at audio recording operation 306, but less complex correlation operations at matched filtering operation 310 as the waveform sound samples 400B, 400C and 400D can each be processed individually and only a single waveform configuration need to be matched. Selection of the appropriate approach can be a configuration decision that depends on intended application, number of devices involved, and nature of environment 100.

As indicated in FIG. 6, each of the respective time series 500B, 500C and 500D can then be processed individually by respective processing channels that each apply shortest path selection, feature extraction and classification operations 312, 315, 316 in the manner described above. With reference to FIG. 1, the time series time series 500B extracted from the received version of sound sample 400B will include multipath results corresponding to LOS propagation path 120B and multiple non-LOS paths 122B. Similarly, as third device 102C is located in the same space 130 (e.g., Room A) as first device 102A, the received version of sound sample 400C will include multipath results corresponding to an LOS propagation path 120C and multiple non-LOS paths (not illustrated). The fourth device 102D, however is not located in the same space 130 as first device 102A, but rather is located in a different space 132 (e.g., Room B) and there is no LOS propagation between fourth device 102D and first device 102A. Accordingly, the received version of sound sample 400D will include multipath results only corresponding to one or more non-LOS propagation paths 122D and will not include any LOS sound segments.

Thus, in the example of FIG. 1, the classification outcome for extracted time series 500B will be that second device 102B IS in the space as first device 102A; the classification outcome for extracted time series 500C will be that third device 102C IS in the space as first device 102A; and the classification outcome for extracted time series 500D will be that fourth device 102D IS NOT in the space as first device 102A.

As indicated in FIG. 6, the classification outcomes can be processed by decision operation 318 to select an action to be taken by first device 102A. For example, in the case where only one capable device (for example third device 102C) is classified as being in the same space as first device 102A, the first device 102A will perform Action A 320, which includes causing content to be automatically shared or projected to the identified “same space” device e.g., third device 102C) without any further user interaction. This action A 320 is represented in FIG. 7B which illustrates first device 102A displaying a GUI that includes lower panel indicating that “Device C-Desktop” is connected for sharing or projection (based on the originally selected GUI button).

In the case where only no devices are classified as being in the same space as first device 102A, the first device 102A will perform Action B 322, which can for example include, as illustrated in FIG. 7C, displaying a list of all of the transmitting devices (e.g., second, third and fourth devices 102B, 102C and 102D) together with an indication that none of the devices are in the same space or room as the first device 102A.

In the case where only no devices are classified as being in the same space as first device 102A, the first device 102A will perform Action B 322, which can for example include, as illustrated in FIG. 7C, displaying a list of all of the transmitting devices (e.g., second, third and fourth devices 102B, 102C and 102D) together with an indication that none of the devices are in the same space or room as the first device 102A.

In the case where only more than one device is classified as being in the same space as first device 102A (for example, as in the scenario of FIG. 1), the first device 102A will perform Action C 324, which can for example include, as illustrated in FIG. 7D, displaying a list of all of the transmitting devices (e.g., second, third and fourth devices 102B, 102C and 102D), with the devices that are classified as being IN the same space as first device 102A being identified as such (e.g., second and third devices 102B and 102C listed as being “Same Room” devices in the illustrated example) and any devices classified as being NOT IN the same space as first device 102A being identified as such (e.g., fourth device 102D listed as being “Different Room”). In example embodiments, user selection of a device from the displayed list will cause the action associated with the originally selected button (e.g., share or projection) to be performed using the selected device.

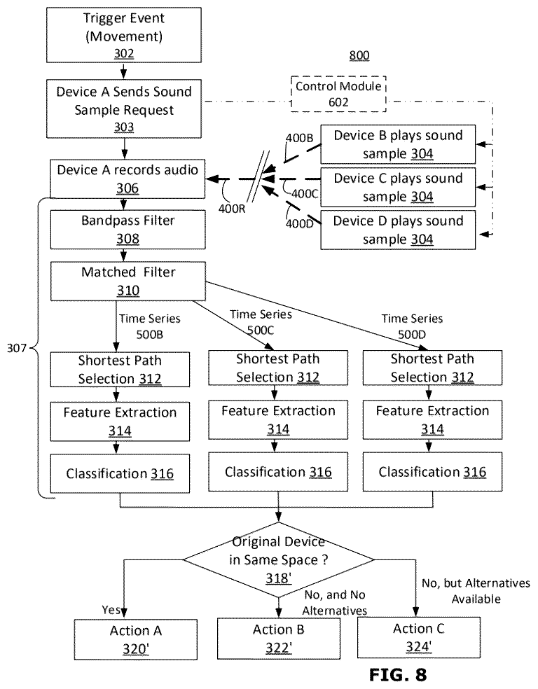

Another example scenario will now be described with reference to same space detection procedure 800 of FIG. 8. Same space detection procedure 800 of FIG. 8 is substantially the same as same space detection procedure 600 with the exception of the trigger condition operation 302 and post classification decision operation and respective actions. In the present scenario, the first device 102A is originally located in Room B 132 of environment 100 with fourth device 102D and is currently in the middle of sharing or projecting content to fourth device 102D to play or display. The first device 102A (a smart phone in the present example) includes an internal IMU 210 (see FIG. 2) that enables the processor system 110 of the first device 102A to estimate an amount of movement of the first device 102A. For example, first device 102A could include a step tracking module that estimates a number of steps taken within a time duration by a user carrying the first device 102A. It will be appreciated that movement of the first device 102A beyond a threshold amount can be an indication that the first device 102A has left the space or room that it was previously located in (for example, the first device 102A may have moved from Room B 132 to Room A 130 in the context of FIG. 1). Accordingly, in an example embodiment, first device 102A is configured to monitor for a trigger event (operation 302) that corresponds to movement above a defined threshold during the time that the first device 102A has been sharing or projecting content to a further device 102 (e.g., to fourth device 102D). In one example, such a trigger event can be a determination, based on data gathered by IMU 210, that the user carrying first device 102A has exceeded a threshold step count, indicating that the first device 102A may have left the space that it was located in when it started a sharing or projecting activity with an external device. In such a scenario, upon detecting a trigger event corresponding to excessive movement, the same space detection procedure 600 can be triggered to perform a same space check that can be used to determine if the first device 102A is still in the same room as the device that it is currently sharing or projecting to and identify other possible sharing/projecting device options if the first device 102A is classified to no longer be in the same room as the device (e.g., fourth device 102D) that it is currently connected to for a sharing or projecting activity.

Upon detecting a movement based trigger event, the subsequent operations of same space detection procedure 800 are the same as those of same space detection procedure 800 until after the classification operation(s) 316.

In particular, in procedure 800, the “same space” classification outcomes are analyzed at decision block 318′ to determine which one of a plurality of possible actions (e.g., Action A 320′; Action B 322′ or Action C 324′) should be taken. In one example, a first step of decision operation 318′ is to determine if the classification outcome in respect of the electronic device 102 (e.g., fourth device 102D in the present example) that the first device 102A was originally connected to for the sharing or projection activity indicates that the first device 102A is still in the same space with such device (e.g., first device 102A is still on Room B 132 with fourth devices 102D). If so, Action A 320′ is selected, which corresponds to carrying on with the status quo of continuing to share or project using fourth device 102D. The decision operation 318′ can also be configured to determine if the classification outcomes indicate that the first device 102A is no longer in the same space as fourth devices 102D, and is not in the same space with any other suitable devices (e.g., No, and No Alternatives), in which case Action B 322′ is performed, which can for example include pausing the sharing or projecting action and causing a GUI list of devices “not in same space but in same network” such as shown in FIG. 7C to be displayed. The decision operation 318′ can also be configured to determine if the classification outcomes indicate that the first device 102A is no longer in the same space as fourth devices 102D, but that one or more other devices 102 are in the same space as first device 102A (e.g., No, but Alternatives Available), in which case Action C 324′ is performed, which can for example include pausing the sharing or projecting action and causing a GUI list of devices “in same space” such as shown in FIG. 7D to be displayed, enabling the user to select an alternative device to continue the sharing or projecting activity with.

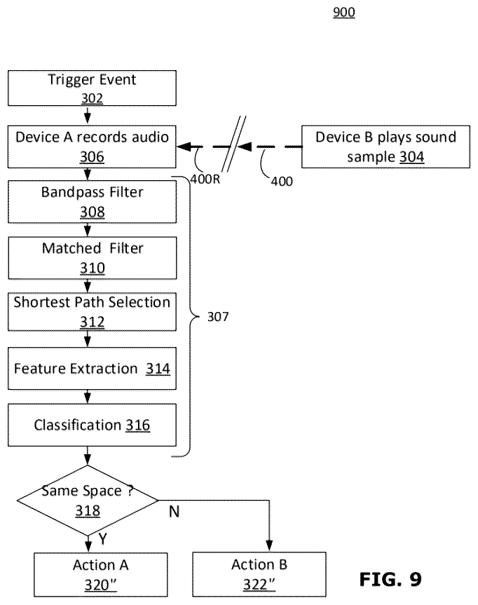

A further example scenario will now be explained with respect to FIG. 9 which shows a further example of a same space detection procedure 900 that is similar to procedure 300 except for differences that will be apparent from the following description. The example scenario of FIG. 9 can represent a meeting room collaboration example. For example a user carrying a first device 102A enters a meeting room that includes a further device, for example device 102D (e.g. a smart TV). The user would like to share content from their first device 102A using fourth device 102D. In the illustrated example, trigger event 302 could be detection of user selection of a “share” button on first device 102A. In the illustrated example, smart TV device 102D is configured to periodically play a sound sample 400 without any prompting. The sound segments 402 within sound sample 400 encodes a universally unique identifier (UUID).

Upon detecting trigger event 302, the first device 102A begins to record a received sound recording 400R for a long enough duration that can capture at least one transmission of the sound sample 400 by device 102D. The first device 102A processes received sound recording 400R using the set of processing operations 307 in the manner described above. The resulting classification outcome is processed by decision operation 318 to select an appropriate action, namely Action A 320″ if the classification outcome indicates that first device 102A is in the same space as device 102D, otherwise Action B 322″ is selected. Action A 320″ causes first device 102A exchange information to build a connection that will enable the desired sharing. Action B 322″ can, for example include display a GUI message on first device 102A indicating that the sharing request has failed do to the devices not being detected as being in the same space, and may also provide the user with an option to cause the first device 102A to loop back to sound sample recording operation 306.

From the above description it will be apparent that the methods, systems and computer media for device detection using active sound sensing disclosed herein can be applied using standard COTS devices and can be more cost and resource efficient and more robust than known detection solutions.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The terms “substantially” and “approximately” as used in this disclosure can mean that the recited characteristic, parameter, or value need not be achieved exactly, but that deviations or variations including for example, tolerances, measurement error measurement accuracy limitations and other factors known to those skilled in the art, may occur in amounts that do not preclude the effect the characteristic was intended to provide. By way of illustration, in some examples, the terms “substantially” and “approximately”, can mean a range of within 5% of the stated characteristic.

As used herein, statements that a second item is “based on” a first item can mean that properties of the second item are affected or determined at least in part by properties of the first item. The first item can be considered an input to an operation or calculation, or a series of operations or calculations that produces the second item as an output that is not independent from the first item.

1. A computer implemented method for predicting device location:
recording, using a microphone on a first device, a sound recording;
processing the sound recording to extract features corresponding to multipath versions of a sound sample played by a second device;
classifying, based on the extracted features, a physical location of the second device as being one of either: (i) located in a same space as the first device, or (ii) not located in the same space as the first device; and
performing an action on the first device based on the classifying.

2. The method of claim 1 wherein the sound sample is within a frequency range that is inaudible to humans.

3. The method of claim 1 wherein processing the sound recording comprises:
performing band pass filtering to obtain a sound signal within a defined frequency band;
performing matched filtering on the sound signal to extract a time series corresponding to the multipath versions of the sound sample played by the second device; and
extracting the features from the time series.

4. The method of claim 3 comprising, prior to extracting the features, processing the time series to identify a first index sound segment within the time series that corresponds to a shortest sound propagation path of the multipath versions of the sound samples from the second device to the first device, the features are extracted based on properties of a subset of the time series selected based on the first index sound segment.

5. The method of claim 4 wherein the features comprise one or more of:
a. a maximum amplitude magnitude value included within the selected subset;
b. an average amplitude magnitude value of the selected subset;
c. a standard deviation amplitude value of the selected subset;
d. a kurtosis amplitude value of the selected subset;
e. a skewness amplitude value of the selected subset;
f. a 25th percentile amplitude value of the selected subset;
g. a 75th percentile amplitude value of the selected subset;
h. a root mean square amplitude value of the selected subset;
i. a number of sampled amplitude values within the selected subset that are larger than a product of a defined coefficient value and the maximum amplitude magnitude value;
j. a sum value of a defined number amplitude peak values occurring within the selected subset;
k. a time offset between a first occurring amplitude peak value and a last amplitude peak value of the selected subset;
l. an average magnitude value of amplitude peak values included within the selected subset;
m. a standard deviation value of amplitude peak values included within the selected subset;
n. a kurtosis value of the amplitude peak values included within the selected subset;
o. a skewness value of the amplitude peak values included within the selected subset;
p. a 25th percentile value of the amplitude peak values included within the selected subset; and
q. a 75th percentile value of the amplitude peak values included within the selected subset.

6. The method of claim 4 wherein processing the time series to identify the first index sound segment comprises: (i) identifying a maximum amplitude peak value within the time series; (ii) identifying if there are any amplitude peak values that meet defined amplitude peak value criteria and are located within a defined search range preceding the maximum amplitude peak value; and (iii) if one or more amplitude peak values are identified within the defined search range, selecting an amplitude peak value that immediately precedes the maximum amplitude peak value to identify the first index sound segment, and if no amplitude peak values are identified within the defined search range, selecting the maximum amplitude peak value to identify the first index sound segment.

7. The method of claim 1 wherein classifying the physical location of the second device comprises applying an artificial intelligence model that has been trained to classify the physical location of the second device as being one of either: (i) located in the same space as the first device, or (ii) not located in the same space as the first device.

8. The method of claim 1 wherein classifying the second device as being located in the same space as the first device corresponds to the second device being physically located within a same room of a building as the first device, and classifying the second device as not being located in the same space as the first device corresponds to the second device not being physically located in the same room of the building as the first device.

9. The method of claim 1 wherein classifying the second device as being located in the same space as the first device corresponds to the second device and the first device both being physically located within a continuous interior space of a vehicle and classifying the second device as not being located in the same space as the first device corresponds to corresponds to the second device and the first device not being both physically located within a continuous interior space of a vehicle.

10. The method of claim 1 wherein the sound sample has a frequency of 17.5 KHz or greater.

11. The method of claim 1 wherein the sound sample has a frequency of between approximately 20 to 24 KHz.

12. The method of claim 10 wherein the sound sample includes a fade-in tone portion, a constant amplitude chirp portion, and a fade-out tone portion.

13. The method of claim 1 wherein performing the action on the first device based on the classifying comprises at least one of the following: (i) causing media content to be automatically streamed for playback through a speaker of the second device when the classifying classifies the physical location of the second device as being located in the same space as the first device (ii) causing a notification output to be generated by the first device indicating an absence of the second device when the classifying classifies the physical location of the second device as not being located in the same space as the first device; and causing the first device to establish a connection with the second device to share media content with the second device when the classifying classifies the physical location of the second device as being located in the same space as the first device.

14. The method of claim 1 wherein the first device, the second device and one or more further devices are each associated with a common wireless network, wherein:
the sound recording includes received multipath versions of the sound sample played by the second device and one or more further sound samples respectively played by the one or more further devices;
processing the sound recording comprises extracting further features, the further features including respective features corresponding to the one or more further sound samples; and
the classifying further comprises classifying, based on the further features, a physical location of each of the one or more further devices as either: (i) the further device being located in a same space as the first device, or (ii) the further device not being located in a same space as the first device.

15. The method of claim 14 comprising:
transmitting, by the first device, a request via the common wireless network for the second device to play the sound sample and the one or more further devices to each play a respective one of the one or more further sound samples, wherein the sound sample and the one or more further sound samples have unique waveform properties that enable the sound sample and the one or more further sound samples to be uniquely identified.

16. The method of claim 15 comprising determining a total number of the second device and the one or more further devices are physically located with the same space with the first device based on the classifying, wherein performing the action on the first device is based on the total number.

17. The method of claim 16 wherein performing the action on the first device comprises: (i) when the total number is one, causing media content to be automatically streamed or shared for playback by the second device or the one more device of the further devices that has been classified as being located in the same space as the first device; (ii) when the total number is greater than one, presenting user selectable device options by the first device that identify devices that have been classified as being located in the same space as the first device; and (iii) when the total number is zero, generating an output by the first device indicating to a user that no devices have been classified as being located in the same space as the first device.

18. A first device comprising:
one or more processors
a microphone operatively connected to the one or more processors; and
one or more memories storing machine-executable instructions thereon which, when executed by the one or more processors, cause the first device to:
record, using the microphone, a sound recording;
process the sound recording to extract features corresponding to multipath versions of a sound sample played by a second device;
classify, based on the extracted features, a physical location of the second device as being one of either: (i) located in a same space as the first device, or (ii) not located in the same space as the first device; and
perform an action based on the classifying.

19. The first device of claim 18 wherein the sound sample is within a frequency range that is inaudible to humans.

20. A non-transitory processor-readable medium having machine-executable instructions stored thereon which, when executed by one or more processors, cause the one or more processors to perform the method of claim 1.
